(19) United States
(12) Patent Application Publication
(10) Pub. No.: US 2023/0238647 A1
(43) Pub. Date: Jul. 27, 2023

(54) MULTI-LAYERED BATTERY VENT MANAGEMENT SYSTEMS FOR TRACTION BATTERY PACKS

(71) Applicant: FORD GLOBAL TECHNOLOGIES, LLC, Dearborn, MI (US)

(72) Inventors: Chung-Hsing KUO, Ann Arbor, MI (US); Yongcai WANG, Ann Arbor, MI (US); LeeAnn WANG, Canton, MI (US); Che-chun CHANG, Ann Arbor, MI (US)

(21) Appl. No.: 17/580,964

(22) Filed: Jan. 21, 2022

(51) Int. Cl. H01M 50/30; H01M 10/658

(52) U.S. Cl. CPC H01M 50/394; H01M 10/658; H01M 2220/20

(57) ABSTRACT

Traction battery pack designs for use in electrified vehicles may include a vent management system adapted for managing battery cell vent byproducts during battery thermal events. The vent management system includes a multi-layered structure, with each layer of the structure having a unique function related to mitigating thermal propagation. The combined functions of the vent management system may include but are not limited to guiding vent byproducts along a desired path and direction, reducing the internal volume of the traction battery pack, and absorbing/trapping solid particles of the vent byproducts.

### TECHNICAL FIELD

This disclosure relates generally to electrified vehicle traction battery packs, and more particularly to multi-layered battery vent management systems adapted for managing the effects of battery thermal events.

### BACKGROUND

Electrified vehicles are designed to reduce or completely eliminate reliance on internal combustion engines. In general, electrified vehicles differ from conventional motor vehicles because they are selectively driven by battery powered electric machines. Conventional motor vehicles, by contrast, rely exclusively on the internal combustion engine to propel the vehicle.

A high voltage traction battery pack typically powers the electric machines and other electrical loads of the electrified vehicle. The traction battery pack includes a plurality of battery cells and various other battery internal components that support the electric propulsion of electrified vehicles.

### SUMMARY

A battery pack according to an exemplary aspect of the present disclosure includes, among other things, a battery array and a vent management system positioned relative to the battery array. The vent management system is multi-layered, with each layer adapted to provide a different function in the event of a battery thermal event of the battery array.

In a further non-limiting embodiment of the foregoing battery pack, the vent management system includes at least a first layer, a second layer, and a third layer.

In a further non-limiting embodiment of either of the foregoing battery packs, the first layer includes a sheet of insulation.

In a further non-limiting embodiment of any of the foregoing battery packs, the second layer includes a baffle frame.

In a further non-limiting embodiment of any of the foregoing battery packs, the third layer includes a filter.

In a further non-limiting embodiment of any of the foregoing battery packs, a fourth layer is configured as a thermal protection layer.

In a further non-limiting embodiment of any of the foregoing battery packs, the vent management system includes a fourth layer. The fourth layer includes a coating.

In a further non-limiting embodiment of any of the foregoing battery packs, the vent management system includes a baffle frame adapted to guide a battery vent byproduct released by the battery array during the battery thermal event.

In a further non-limiting embodiment of any of the foregoing battery packs, the baffle frame includes an outer frame and a plurality of guide arms that extend from the outer frame.

In a further non-limiting embodiment of any of the foregoing battery packs, the vent management system includes at least an insulation layer, a baffle frame, and a filtering layer.

A battery pack according to another exemplary aspect of the present disclosure includes, among other things, an enclosure assembly, a battery array housed within the enclosure assembly, and a vent management system disposed between the battery array and an interior surface of the enclosure assembly. The vent management system includes multiple layers. At least one layer of the multiple layers includes a baffle frame adapted to guide a battery vent byproduct released by the battery array in the event of a battery thermal event.

In a further non-limiting embodiment of the foregoing battery pack, the internal surface is part of a cover of the enclosure assembly.

In a further non-limiting embodiment of either of the foregoing battery packs, the baffle frame is disposed between an insulation layer and a filtering layer of the multiple layers.

In a further non-limiting embodiment of any of the foregoing battery packs, the vent management system includes a thermal protection layer.

In a further non-limiting embodiment of any of the foregoing battery packs, the baffle frame includes an outer frame and a plurality of guide arms that extend from the outer frame.

In a further non-limiting embodiment of any of the foregoing battery packs, the plurality of guide arms establish vent passages for directing the battery vent byproducts along a desired flow path.

In a further non-limiting embodiment of any of the foregoing battery packs, the vent passages fluidly connect to a main vent passage of the baffle frame.

In a further non-limiting embodiment of any of the foregoing battery packs, the plurality of guide arms each include a main body attached to the outer frame and an angled portion that extends from the main body.

In a further non-limiting embodiment of any of the foregoing battery packs, the vent management system includes the baffle frame, an insulation layer, and a filtering layer.

In a further non-limiting embodiment of any of the foregoing battery packs, the vent management system includes an insulation layer, the baffle frame, a filtering layer, and a thermal protection layer.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates a powertrain of an electrified vehicle.

FIG. 2 is an exploded cross-sectional view of an exemplary traction battery pack that includes a vent management system.

FIG. 3 illustrates another exemplary vent management system for a traction battery pack.

FIG. 4 is a top perspective view of a baffle frame of the vent management system of FIG. 2.

### DETAILED DESCRIPTION

This disclosure details exemplary traction battery pack designs for use in electrified vehicles. An exemplary traction battery pack may include a vent management system adapted for managing battery cell vent byproducts during battery thermal events. The vent management system includes a multi-layered structure, with each layer of the structure having a unique function related to mitigating thermal propagation. The combined functions of the vent management system may include but are not limited to guiding vent byproducts along a desired path and direction, reducing the internal volume of the traction battery pack, and absorbing/trapping solid particles of the vent byproducts. These and other features are discussed in greater detail in the following paragraphs of this detailed description.

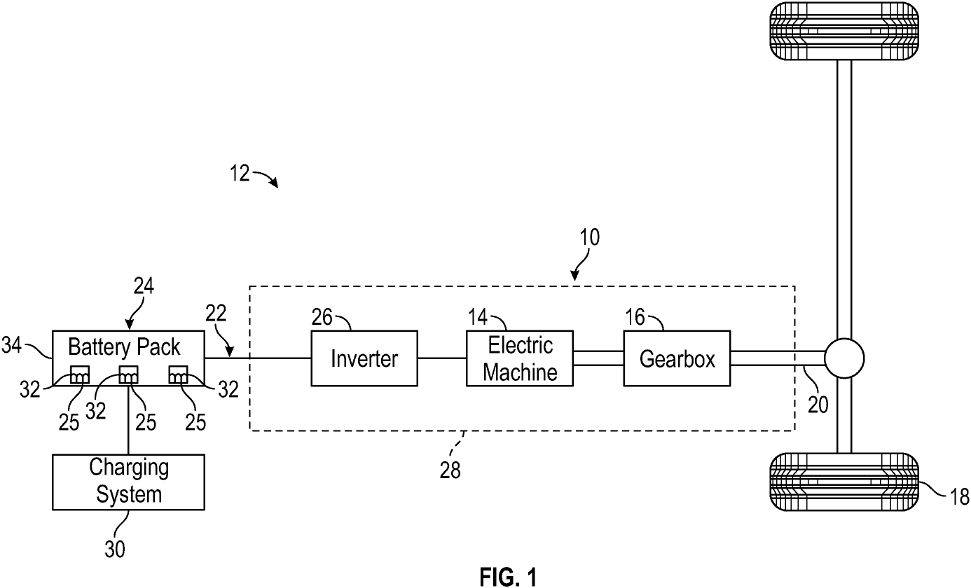

FIG. 1 schematically illustrates a powertrain 10 of an electrified vehicle 12. In an embodiment, the electrified vehicle 12 is a battery electric vehicle (BEV). However, it should be understood that the concepts described herein are not limited to BEVs and could extend to other electrified vehicles, including, but not limited to, hybrid electric vehicles (HEVs), plug-in hybrid electric vehicles (PHEVs), fuel cell vehicles, etc. Although not shown in this exemplary embodiment, the electrified vehicle 12 could be equipped with an internal combustion engine that can be employed either alone or in combination with other energy sources to propel the electrified vehicle 12.

In the illustrated embodiment, the electrified vehicle 12 is a full electric vehicle propelled solely through electric power, such as by an electric machine 14, without any assistance from an internal combustion engine. The electric machine 14 may operate as an electric motor, an electric generator, or both. The electric machine 14 receives electrical power and provides a rotational output torque. The electric machine 14 may be connected to a gearbox 16 for adjusting the output torque and speed of the electric machine 14 by a predetermined gear ratio. The gearbox 16 may be operably connected to a set of drive wheels 18 by an output shaft 20.

A voltage bus 22 electrically connects the electric machine 14 to a traction battery pack 24 through an inverter 26, which can also be referred to as an inverter system controller (ISC). The electric machine 14, the gearbox 16, and the inverter 26 may be collectively referred to as a transmission 28 of the electrified vehicle 12.

The traction battery pack 24 is an exemplary electrified vehicle battery. The traction battery pack 24 may be a high voltage traction battery pack that includes one or more battery arrays 25 (i.e., battery assemblies or groupings of battery cells) capable of outputting electrical power to operate the electric machine 14 and/or other electrical loads of the electrified vehicle 12. Other types of energy storage devices and/or output devices can also be used to electrically power the electrified vehicle 12.

The one or more battery arrays 25 of the traction battery pack 24 may each include a plurality of battery cells 32 that store energy for powering various electrical loads of the electrified vehicle 12. The traction battery pack 24 could employ any number of battery cells 32 within the scope of this disclosure. Accordingly, this disclosure should not be limited to the exact configuration shown in FIG. 1.

In an embodiment, the battery cells 32 are lithium-ion cells. However, other cell chemistries (nickel-metal hydride, lithium-iron phosphate, etc.) could alternatively be utilized within the scope of this disclosure.

In another embodiment, the battery cells 32 are cylindrical, prismatic, or pouch battery cells. However, other cell geometries could alternatively be utilized within the scope of this disclosure.

An enclosure assembly 34 may house the battery arrays 25 of the traction battery pack 24. In an embodiment, the enclosure assembly 34 is a sealed outer enclosure that establishes the outermost surfaces of the traction battery pack 24. The enclosure assembly 34 may include any size, shape, and configuration within the scope of this disclosure. The battery arrays 25 and other battery internal components of the traction battery pack are separate structures from the enclosure assembly 34 and therefore are not considered to established any portion of the outermost surfaces of the traction battery pack 24.

The electrified vehicle 12 may also include a charging system 30 for charging the energy storage devices (e.g., the battery cells 32) of the traction battery pack 24. The charging system 30 may include charging components that are located both onboard the electrified vehicle 12 (e.g. vehicle charge port assembly, etc.) and external to the electrified vehicle 12 (e.g., electric vehicle supply equipment (EVSE), etc.). The charging system 30 can be connected to an external power source (e.g., a grid power source) for receiving and distributing power received from the external power source throughout the electrified vehicle 12.

The powertrain 10 depicted by FIG. 1 is highly schematic and is not intended to limit this disclosure. Various additional components could alternatively or additionally be employed by the powertrain 10 within the scope of this disclosure.

During operation of the electrified vehicle 12, the battery cells 32 and other internal components of the traction battery pack 24 can experience a rare event known as thermal runaway during certain battery thermal events (e.g., overcharging, overdischarging, overheating, etc.). Further, during such conditions, the battery cells 32 may vent gases and/or other effluents into the interior of the enclosure assembly 34. The vent gases may be caused by an applied force or a thermal event, and can either cause or exacerbate an existing battery thermal event. A relatively significant amount of heat can be generated during battery thermal events, and if not contained, the generated heat can cascade to other battery internal components, thereby accelerating thermal runaway. This disclosure is therefore directed to traction battery pack designs that incorporate multi-layered vent management systems for managing battery cell vent byproducts and mitigating thermal propagation within the interior of the traction battery pack when battery thermal events occur.

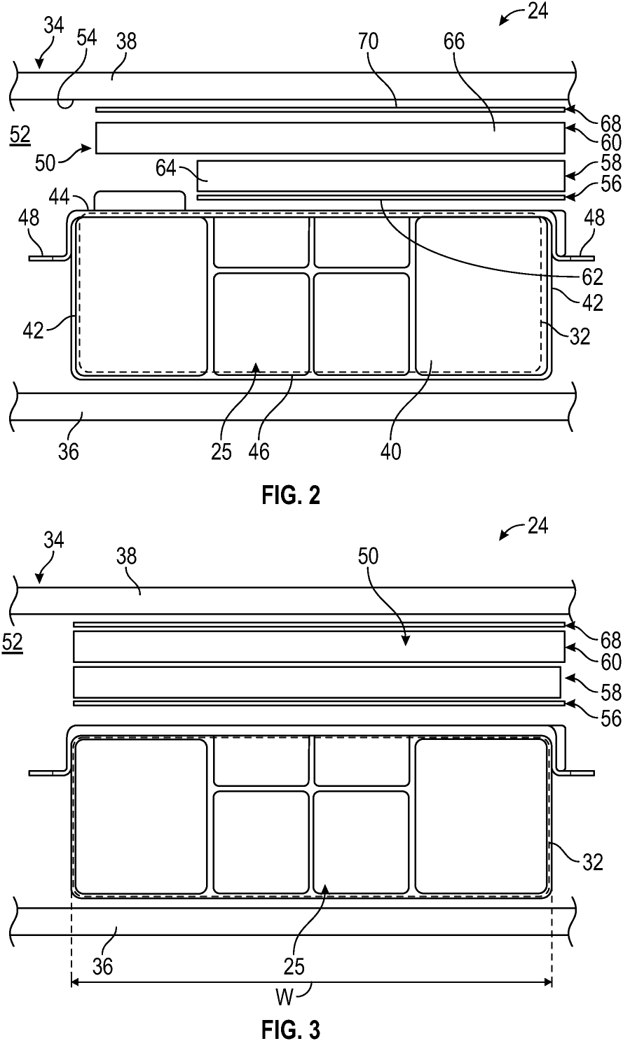

FIG. 2 illustrates, in an exploded cross-sectional view, select portions of a traction battery pack 24 that may be utilized within an electrified vehicle. For example, the traction battery pack 24 could be employed as part of the powertrain 10 of the electrified vehicle 12 of FIG. 1 or any other electrified vehicle.

The enclosure assembly 34 of the traction battery pack 24 may be a sealed enclosure that includes a tray 36 and a cover 38. The tray 36 and the cover 38 may be constructed of metallic materials, polymer-based materials, textile materials, or any combination of these materials. The tray 36 could include the same or a different material make-up than from the cover 38.

Once the cover 38 is secured to the tray 36, the enclosure assembly 34 may establish an interior for holding battery arrays 25 and other battery internal components of the traction battery pack 24. The interior may be established by inner walls/surfaces of both the tray 36 and the cover 38.

The traction battery pack 24 may include one or more battery arrays 25 housed within the interior of the enclosure assembly 34. Although the traction battery pack 24 of FIG. 2 is depicted as having a single battery array, the traction battery pack 24 could be provided with a greater number of battery arrays within the scope of this disclosure. Furthermore, although not shown, one or more battery internal components (e.g., bussed electrical center (BEC), battery electric control module (BECM), electrical wiring, etc.) could additionally be housed within the interior of the enclosure assembly 34.

The battery array 25 may be positioned atop the tray 36. The cover 38 may then be received over the battery array 25 and mounted to the tray 36 to assemble the enclosure assembly 34.

The battery array 25 may include a support structure that substantially surrounds the battery cells 32, which may be arranged side-by-side along a stack axis to construct a grouping or “cell stack” of the battery cells 32. The support structure may include a pair of end plates 40, a pair of side plates 42, a top plate 44, and a bottom plate 46. One or more of the plates (here, the top plate 44) of the support structure may include mounting flanges 48 that provide fixation points for fixedly mounting (e.g., bolting, welding, etc.) the battery array 25 relative to the tray 36 or some other mounting structure disposed inside of the enclosure assembly 34 of the traction battery pack 24.

The traction battery pack 24 may additionally include a vent management system 50 that is configured for managing battery cell vent byproducts that can be expelled by the battery cells 32 of the battery array 25 during battery thermal events. The vent management system 50 may include a multi-layered structure, with each layer of the structure having a unique function associated with venting and mitigating thermal propagation inside the traction battery pack 24. As further explained below, the vent management system 50 may be capable of performing functions such as guiding battery cell vent byproducts along a desired path/direction, reducing/organizing the internal volume of the traction battery pack 24, absorbing/trapping solid particulates of the battery cell vent byproducts, etc.

The vent management system 50 may be disposed between the battery array 25 and any internal surface of the enclosure assembly 34. In the illustrated embodiment, the vent management system 50 is disposed within a space 52 that extends between the top plate 44 of the battery array 25 and an interior surface 54 of the cover 38. However, other positions and configurations of the vent management system 50 are contemplated within the scope of this disclosure.

The vent management system 50 may include a first layer 56, a second layer 58, and a third layer 60. Notably, the various layers of the vent management system 50 are not drawn to scale, and in the interests of simplicity and clarity, are shown in a highly schematic manner.

In an embodiment, the first layer 56 is the layer of the vent management system 50 that is positioned closest to the battery array 25. In the fully assembled condition of the traction battery pack 24, the first layer 56 may contact the battery array 25, such as by being positioned in direct contact with the top plate 44, for example. The second layer 58 may be disposed (e.g., sandwiched) between the first layer 56 and the third layer 60. The third layer 60 may be disposed on an opposite side of the second layer 58 from the first layer 56 and is therefore located further away from the battery array 25 than the first layer 56.

The first layer 56 may include a sheet of insulation 62 and may thus be referred to as an insulation layer. The first layer 56 is designed to thermally protect the battery array 25 and its various electronics and to reduce electrical conduction. The insulation 62 may be made of a mica-based product or some other suitable dielectric material.

The second layer 58 may include a baffle frame 64. The baffle frame 64 may be designed to perform functions such as organizing the space 52, reducing the volume of the space 52, guiding battery cell vent byproducts along a desired direction/path, etc. The baffle frame 64 may be made of materials such as metals, clay, ceramics, etc.

The baffle frame 64 may be fixed in place (e.g., welded, bolted, etc.) relative to the battery array 25. In an embodiment, the baffle frame 64 is secured directly to the top plate 44. In another embodiment, the baffle frame 64 is secured directly to the cover 38.

The third layer 60 may include a filter 66 and may thus be referred to a as a filtering layer. The third layer 60 is designed to trap particles, liquids, etc. that may be encompassed within the battery cell vent byproducts that could be released by the battery cells 32 during battery thermal events. The filter 66 may be a fiberglass non-woven mesh mat, for example. However, other materials and configurations of the filter 66 are further contemplated within the scope of this disclosure.

The vent management system 50 may further optionally include a fourth layer 68. The fourth layer 68 may be designed to reduction thermal radiation and may therefore be referred to as a thermal protection layer. The fourth layer 68 may include a coating 70 that exhibits low emissivity and high thermal conductivity, for example. In an embodiment, the coating 70 may be an aluminum based coating. However, other materials are further contemplated within the scope of this disclosure.

If provided, the fourth layer 68 may be applied to the interior surface 54 of the cover 38. The fourth layer 68 may thus be the layer of the vent management system 50 that is positioned the furthest away from the battery array 25.

In an embodiment, one or more of the various layers of the vent management system 50 may include a different size, shape, and/or pattern, etc. relative to the other layers of the system 50 (see, e.g., FIG. 2), such as for accommodating components (e.g., busbars, terminals, etc.) of the battery array 25. In another embodiment, the various layers of the vent management system 50 may include a common size and shape, such as a size/shape that substantially matches a width W of the battery array 25, for example (see, e.g., FIG. 3).

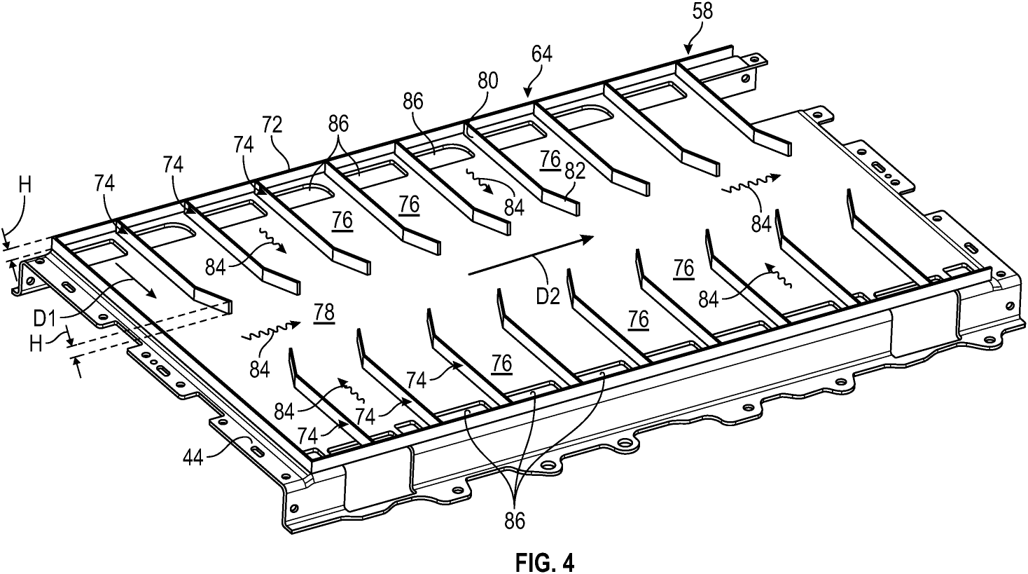

The baffle frame 64 of the second layer 58 of the vent management system 50 is further detailed with reference to FIG. 4 (with continued reference to FIGS. 1-2). The baffle frame 64 may include an outer frame 72 and a plurality of guide arms 74 that extend inwardly from the outer frame 72. The outer frame 72 and the guide arms 74 are of a sufficient height H for establishing passageways for guiding battery vent byproducts 84 along desired paths/directions.

The guide arms 74 may be arranged to establish a plurality of vent passages 76. The vent passages 76 may fluidly connect to a main vent passage 78 of the baffle frame 64. In an embodiment, the main vent passage 78 is disposed between guide arms 74 that are located on opposite sides of the outer frame 72.

Each guide arm 74 may include a main body 80 and an angled portion 82 that extends from the main body 80. The main body 80 may connect to the outer frame 72, and the angled portion 82 may extend from a portion of the main body 80 that is located on an opposite end from the portion that is connected to the outer frame 72.

During some battery thermal events, the battery cells 32 of the battery array 25 can release battery vent byproducts 84. The battery vent byproducts 84 may include gases, solids, liquids, and/or other byproducts or combinations of byproducts that can be released by the battery cells 32. The battery vent byproducts 84 may be released through battery cell vent ports (not shown) and may escape through openings 86 formed in the top plate 44 of the battery array 25.

Upon entering the second layer 58 of the vent management system 50 through the openings 86, the battery vent byproducts 84 may then matriculate through the vent passages 76 prior to entering the main vent passage 78. In an embodiment, the battery vent byproducts 84 flow in a first direction D1 within the vent passages 76 and flow in a second direction D2 within the main vent passage 78. The second direction D2 may be transverse (e.g., perpendicular) to the first direction D1. The angled portions 82 of the guide arms 74 may help re-direct the battery vent byproducts 84 from the first direction D1 to the second direction D2 to move the battery vent byproducts 84 along a desired flow path of the baffle frame 64. The battery vent byproducts 84 may then be expelled from the traction battery pack 24 (e.g., to atmosphere), thereby preventing the relatively hot vent byproducts from propagating throughout the traction battery pack 24.

The exemplary vent management systems of this disclosure are designed to better manage battery cell vent byproducts during battery thermal events of a traction battery pack. The vent management systems may provide numerous advantages including but not limited to segmenting the pack internal air volume to prevent vent gases from spreading and contaminating neighboring battery cells, absorbing vent gas solid/liquid contents, trapping high temperature particles of vent byproducts, providing guided vent gas flow paths, and enabling multiple functions to manage thermal propagation.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

1. A battery pack, comprising:
a battery array; and
a vent management system positioned relative to the battery array,
wherein the vent management system is multi-layered, with each layer adapted to provide a different function in the event of a battery thermal event of the battery array,
wherein the vent management system includes at least an insulation layer, a filtering layer, and a baffle frame sandwiched between the insulation layer and the filtering layer.

2. (canceled)

3. The battery pack as recited in claim 1, wherein the insulation layer includes a sheet of insulation.

4. (canceled)

5. The battery pack as recited in claim 1, wherein the filtering layer includes a filter.

6. The battery pack as recited in claim 1, wherein the vent management system includes a thermal protection layer that includes a coating.

7. (canceled)

8. The battery pack as recited in claim 1, wherein the baffle frame is adapted to guide a battery vent byproduct released by the battery array during the battery thermal event.

9. The battery pack as recited in claim 8, wherein the baffle frame includes an outer frame and a plurality of guide arms that extend from the outer frame.

10. (canceled)

11. A battery pack, comprising:
an enclosure assembly including a cover and a tray;
a battery array housed within the enclosure assembly and including a plurality of battery cells arranged within a support structure that includes a pair of end plates, a pair of side plates, a top plate, and a bottom plate; and
a vent management system disposed between the top plate and an interior surface of the cover,
wherein the vent management system includes multiple layers,
wherein at least one layer of the multiple layers includes a baffle frame adapted to guide a battery vent byproduct released by the battery array in the event of a battery thermal event.

12. The battery pack as recited in claim 11, wherein the interior surface is part of a cover of the enclosure assembly.

13. The battery pack as recited in claim 11, wherein the baffle frame is disposed between an insulation layer and a filtering layer of the multiple layers.

14. The battery pack as recited in claim 13, further comprising a thermal protection layer.

15. The battery pack as recited in claim 11, wherein the baffle frame includes an outer frame and a plurality of guide arms that extend from the outer frame.

16. The battery pack as recited in claim 15, wherein the plurality of guide arms establish vent passages for directing the battery vent byproducts along a desired flow path.

17. The battery pack as recited in claim 16, wherein the vent passages fluidly connect to a main vent passage of the baffle frame.

18. The battery pack as recited in claim 15, wherein the plurality of guide arms each include a main body attached to the outer frame and an angled portion that extends from the main body.

19. The battery pack as recited in claim 11, wherein the vent management system includes the baffle frame, an insulation layer, and a filtering layer.

20. The battery pack as recited in claim 11, wherein the vent management system includes an insulation layer, the baffle frame, a filtering layer, and a thermal protection layer.

21. The battery pack as recited in claim 1, wherein the insulation layer includes a mica-based product, and the filtering layer includes a fiberglass non-woven mesh mat.

22. The battery pack as recited in claim 1, wherein each of the insulation layer, the filtering layer, and the baffle frame includes a different size and shape compared to each additionally layer of the vent management system.

23. The battery pack as recited in claim 6, wherein the coating is an aluminum based coating.

24. A battery pack, comprising:
an enclosure assembly including a cover and a tray;
a battery array housed within the enclosure assembly and including a plurality of battery cells surrounded by a support structure that includes a pair of end plates, a pair of side plates, a top plate, and a bottom plate; and
a vent management system disposed between the top plate and an interior surface of the cover,
wherein the vent management system includes an insulation layer, a filtering layer, and a baffle frame sandwiched between the insulation layer and the filtering layer,
wherein the insulation layer includes a mica-based product,
wherein the filtering layer includes a fiberglass non-woven mesh mat,
wherein the baffle frame is secured directly to the top plate or the cover and is adapted to guide a battery vent byproduct released by the battery array in the event of a battery thermal event,
wherein the baffle frame includes an outer frame, a first group of guide arms that extend from a first side of the outer frame, and a second group of guide arms that extend from a second side of the outer frame,
wherein the first group and the second group of guide arms each establish a vent passage for directing the battery vent byproduct along a desired flow path,
wherein the vent passages fluidly connect to a main vent passage of the baffle frame,
wherein the main vent passage is positioned axially between the first group and the second group of guide arms.
